(19) United States
(12) Patent Application Publication
(10) Pub. No.: US 2012/0158371 A1
(43) Pub. Date: Jun. 21, 2012

(54) Method of Assisting Planning of a Technical System

(75) Inventors: Thomas Ehben, Friedeburg (DE); Thilo Tetzner, Nurnberg (DE)

(73) Assignee: Siemens Aktiengesellschaft, Muenchen (DE)

(21) Appl. No.: 13/393,182

(22) PCT Filed: Aug. 17, 2010
(86) PCT No.: PCT/EP2010/061939

§ 371 Date: Feb. 28, 2012

(30) Foreign Application Priority Data
Aug. 31, 2009 (EP) 0901179.0
Jan. 27, 2010 (EP) 10000826.7

(51) Int. Cl. G06F 17/50

(52) U.S. Cl. 703/1

(57) ABSTRACT

A method or a software application which is used to assign artifacts of technical systems to the process steps required to produce them, wherein the assignments comprise annotations, and the method provides an editor for the annotations. A graphical user interface is also provided, which can be used to visualize the artifacts (e.g., documents describing structural elements) of the technical system and individual process steps (or entire process cycles) and to input the annotations between the two in graphical or tabular form and process them. Pre-existing special knowledge in the domain and the craft relating to plant engineering is acquired, processed, preserved and imparted using the method of the invention. The method advantageously provides effective support for document and configuration management, where CAD and project management tools are integrated to give a systematic IT landscape without media clashes.

### CROSS-REFERENCE TO RELATED APPLICATIONS

This is a U.S. national stage of application No. PCT/EP2010/061939 filed 17 Aug. 2010. Priority is claimed on European Application No. 09011179.0 filed 31 Aug. 2009 and European Application No. 10000826.7 filed 27 Jan. 2010, the contents of which are incorporated herein by reference in its entirety.

### BACKGROUND OF THE INVENTION

1. Field of the Invention

The present invention relates to computer aided system design and, more particularly, to a method for assisting planning of a technical system.

2. Description of the Related Art

In industrial plant engineering, it is necessary to assemble components and modules to form a customer-specific technical system. The technical system may, for instance, be industrial systems, factories, power plants, systems for distributing power, water and gas and also oil and gas pipelines. Generally, these technical systems contain individual systems and subsidiary activities.

Activities and/or subsidiary activities include specific technical and, if necessary, also non-technical, possibly commercial activities, which are needed to plan a technical system (e.g., a roller plant) or an industrial product (e.g., a purchased welding machine for a roller plant) throughout its entire lifecycle, to develop, produce and/or realize and operate the same. Aside from activities requiring engineering knowledge, activities therefore also refer in particular to special knowledge of a specialist field with all its facets (such as marketing, development, commissioning, operation or maintenance). Subsidiary activities refer to activities that assume a subordinate role in the technical system or execute an auxiliary function.

In the planning of a technical system, the following activities frequently play a role for instance: electrical engineering, machine building and automation technology. As subsidiary activities, building technology, safety engineering, pneumatics and hydraulics are mentioned. The business of plant engineering essentially distinguishes two working phases. Order-independent preliminary work occurs during a first phase in the office of a plant manufacturer. Valid working steps and reusable engineering artifacts are generally devised and prepared there. As a result, knowledge is generated and managed for plant engineering.

Once the plant manufacturer obtains a customer order to build a specific technical system, a second phase entailing order-dependent planning work is activated. This second phase begins with a determination of basic data of the technical system, the preparation of specifications and planning work for all parts of the technical system. These activities are also mainly associated with office work. In the further project workflow of the second phase, there is generally a smooth transition from the planning to the installation of the technical system. The technical system is physically created onsite at the customer's location, put into operation and handed over to the customer.

Conventionally, both phases are assisted by a plurality of problem- and activity-oriented IT and software tools. Applications for Computer Aided Design (CAD), Probalistic Logic Network (PLN), project and document management are above all used. These applications nevertheless function largely independently of one another and are not integrated or networked so that a meaningful interaction is only possible by the cooperation and experience of the plant manufacturer's employees.

Artifacts are physical and ideal components of the technical system. These are either present as documents or are represented by documents. Examples of artifacts are floor plans, circuit diagrams, computer programs, documentation, protocols or licenses.

### SUMMARY OF THE INVENTION

It is an object of the present invention to provide a method for assisting in the planning of a technical system that reduces the expenditure of time when planning the technical system.

This and other objects and advantages are achieved in accordance with the invention by programming a microprocessor to assign artifacts of the technical system to process steps, which are required to produce the artifacts, by annotations being produced. Furthermore, the microprocessor is programmed to enable a user to detect the annotations with the aid of a graphical user interface and to process the annotations.

In accordance with the invention, a method and/or software application is provided, with which artifacts of technical systems can be assigned to the process steps required for their production. These assignments are referred to as annotations, whereby the method provides some sort of editor for the annotations.

An essential component for this is the graphical user interface. With this, the artifacts (e.g., documents describing structural elements) of the technical system and individual process steps (and/or entire process cycles) can be visualized and the annotations between the two can be input in graphical or tabular form, for instance, and processed. If necessary, both the artifacts and also the process steps are shown hierarchically, here. The basic functions are furthermore the production, modification and deletion of annotations.

Already existing special knowledge in the domain and the activities relating to plant engineering is acquired, processed, preserved and imparted using the method in accordance with the invention. Knowledge management is thus enabled for the plant manufacturer. New possibilities result across the organization of commercializing existing specialist knowledge. Annotation libraries can therefore be marketed as an individual product or as an addition to the plant components.

A further advantage lies in effective assistance for a document and configuration management via the method in accordance with the invention. CAD and project management tools are integrated to give a systematic IT landscape without media clashes. The predictability of project planning and project management is improved because risks can be identified better and can be by-passed by adapting the preplanned project execution.

The method in accordance with the invention further allows the representation of the details of the execution of large projects in plant engineering in a generally intelligible manner and their interdisciplinary communication.

CAD and project management applications were up to now already widely developed and established. Conventional applications used in plant engineering were, however, not explicitly networked with one another, so that process steps required for the planning and building of the technical system had to be defined outside of these applications. The conventional applications operate in their own structures depending on the activity. Existing assignments of process steps (and/or process cycles) to plant parts (and/or their artifacts) have therefore grown historically and were common practice. A digital connection with the structure of the technical system did not exist, here. Their availability and quality therefore depended essentially on the experience of the employees. All these disadvantages are reduced or eliminated by the method in accordance with the invention.

In an embodiment, one or several artifacts each form a mechatronic object. Existing Plant Lifecycle Management (PLM) models can be managed as complete mechatronic objects by the annotations. A realization of integral mechatronic objects is assisted by the integration of PLM and workflow models.

Aside from the above-described embodiments of the method in accordance with the invention, it is also an object to provide a machine-readable data carrier, on which a computer program is stored, which executes one of the disclosed embodiments methods in accordance with the invention if it is executed in a computer.

Furthermore, the invention includes a computer program stored on computer memory, which is run in a computer and herewith executes one of the discloses embodiments of the method in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are described in more detail below with the aid of the Figures, in which:

FIG. 1 shows an overview of the method in accordance with an embodiment of the invention;

FIG. 2 shows representations of annotations in accordance with an embodiment of the invention;

FIG. 3 shows representation of annotations in accordance with alternative embodiment of the invention; and

FIG. 4 shows a computer on which the method in accordance with the invention is executed.

### DETAILED DESCRIPTION OF THE PREFERRED EMBODIMENTS

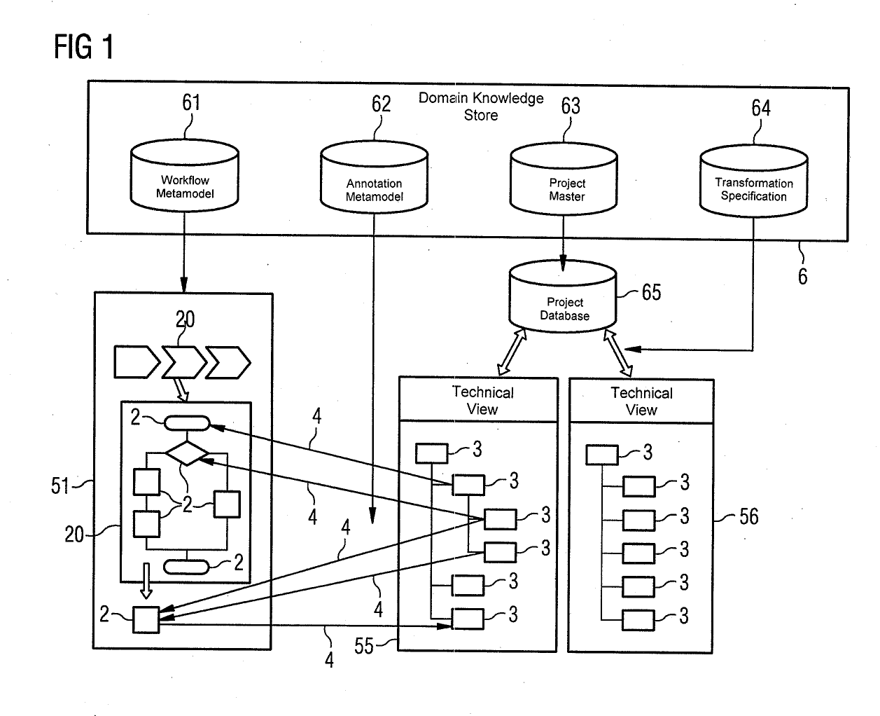

FIG. 1 shows the method of assisting the planning of a technical system and various optional extensions. In the left part of FIG. 1, a work flow view 51 is shown, in which work flows, which are needed for the planning and installation of the technical system, are shown visually. A work package 20 is shown, inter alia, which is arranged in the upper part of the work flow view 51 in a chain of work packages. The work package 20 is shown in detail in the central part of the work flow view 51. The work package 20 contains a work flow, which consists of process steps 2.

A first technical view 55 and a second technical view 56 are shown to the right adjacent to the work flow view 51. The first technical view 55 and the second technical view 56 each contain artifacts 3 in a hierarchical arrangement. In accordance with the method of the invention, those process steps 2, which are required to produce artifacts 3, are now assigned hereto. To this end, annotations 4 are produced that are likewise shown in FIG. 1. The described elements from FIG. 1 are to this end shown on a graphical user interface so that a user is able to detect and process the annotations 4.

FIG. 1 shows further optional components of the method in accordance with the invention. A domain knowledge store 6 is visible in the upper part, which stores knowledge from the plant engineering and provides the same for future projects. To this end, the domain knowledge store 6 includes a work flow metamodel 61, which is used as a master for the work package 20 and the process steps 2. The domain knowledge store 6 also contains an annotation metamodel 62, which is used as a master for the annotations 4. Thirdly, the domain knowledge store 6 includes a project master 63. With the aid of this, a project database 65 is generated, the contents of which can be visualized through the first technical view 55 and through the second technical view 56. During visualization, transformation specifications 64 are also taken into account, which are also contained in the domain knowledge store 6.

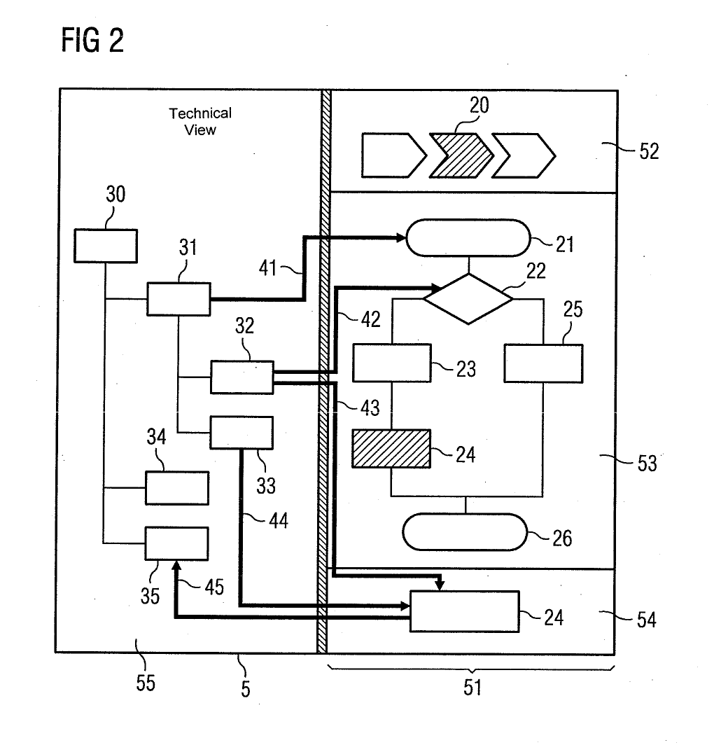

FIG. 2 shows the first technical view 55 from FIG. 1 in detail in the left half, and the work flow view 51 from FIG. 1 in detail in the right half. Here, the first technical view 55 includes here an object 30, which breaks down hierarchically into a first artifact 31, a second artifact 32, a third artifact 33, a fourth artifact 34 and a fifth artifact 35. The work flow view 51 breaks down into three segments. The work package view 52 at the top shows complete work packages, inter alia, the work package 20. The work flow detailed view 53 shows a work flow in detail in each instance, of which the respective work package, the work package 20, consists. The process step view 54 contains an individual process step from the work flow detailed view 53. The work flow detailed view 53 firstly shows a start 21 as a work flow, followed by a decision 22, which in the first case results in a first process step 23 and a second process step 24 and in the second case results in a third process step 25. The work flow ends with an end 26. Furthermore, FIG. 2 shows a first input annotation 41, a second input annotation 42, a third input annotation 43 and a fourth input annotation 44. The input annotations each show which artifacts are required in the first technical view 55 for a process step in the work flow detailed view 53 or the process step view 54. The first artifact 31 is therefore required for the start 21 of the work flow. The second artifact 32 is required for the decision 22 and for the second process step 24. The third artifact 33 is likewise a prerequisite for the second process step 24.

FIG. 2 also shows an output annotation 45, which specifies which artifact is produced by which process step. According to FIG. 2, the fifth artifact 35 is produced by the second process step 24.

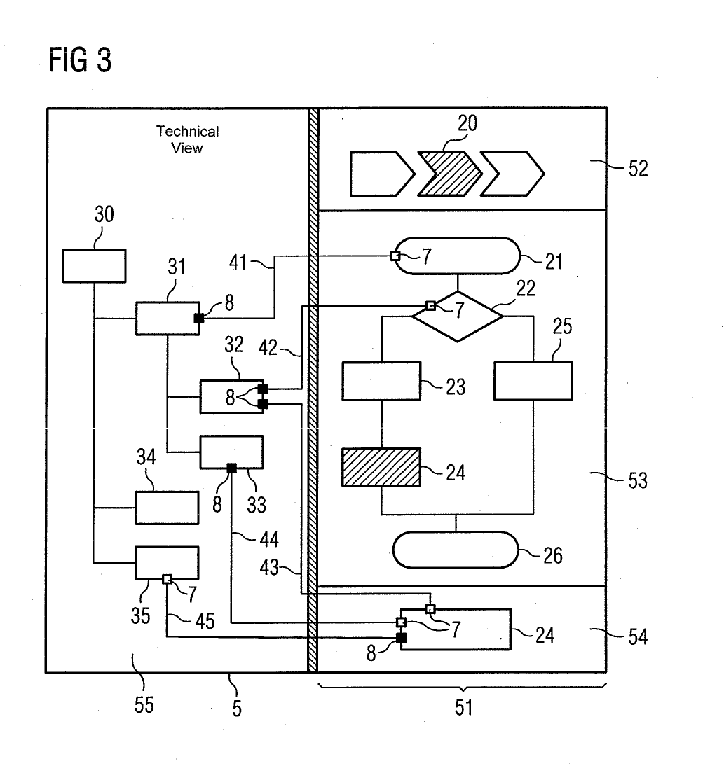

FIG. 3 shows an alternative representation of the annotations from FIG. 2. Here, the same reference characters refer to the same elements as in FIG. 2. An alternative representation is selected from the representation of the first input annotation 41, the second input annotation 42, the third input annotation 43 and the fourth input annotation 44. The respective artifact is extended with an output port 8 in the visual representation. The associated process step is extended by an input port 7. Here, the annotation connects the output port 8 to the input port 7. For the representation of the output annotation 45, the second process step 24 is provided with the output port 8. The fifth artifact 35 is provided with the input port 7. The fifth artifact 35 is provided with the input port 7. With the aid of the different representation of the input port 7 (an empty square in FIG. 3) and of the output port 8 (a black-filled square in FIG. 3), it is possible to distinguish whether this is an input annotation or an output annotation.

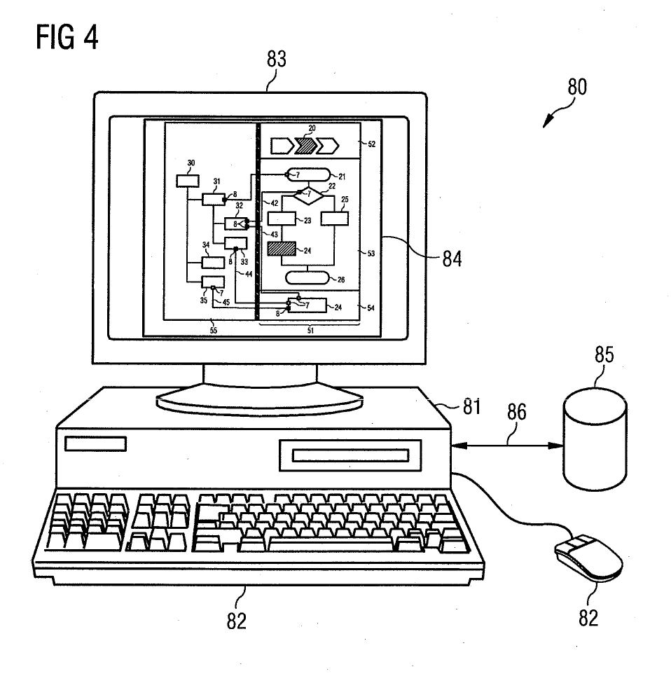

FIG. 4 shows a system 80, on which the method is executed. The system 80 includes a computer 81, such as a PC, laptop or personal digital assistant (PDA). A user interface 84, which shows the contents of FIG. 3, is located on a monitor 83 of the computer 81. The computer 81 also has input devices 82, for instance keyboard and mouse, as well as a memory 85, such as a memory on a server or a local memory. The memory 85 is connected to the computer 81 by way of a data link 86.

Reference is made again below to FIG. 1. The previously described representations lend themselves to implementing known representation and interaction standards of graphical editors. To this end, a selective representation or masking out hierarchy levels is included both in the work flow view 51 and in the first technical view 55. It is furthermore advantageous to deposit the respective contents in libraries. The annotations 4 are preferably shown as flylines. An automatic conversion into axially-parallel, non-overlapping line segments (i.e., autorouting) features here. Comments can be masked in and out. According to current practice, artifacts 3 are shown as blocks and work packages, such as work package 20, are shown as block arrows. It is naturally also possible to deviate herefrom. The annotations 4 are shown as lines, optionally with arrow tips. Both the artifacts 3 and also the process steps 2 can be provided with docking sites (the input port 7 and output port 8 shown in FIG. 3), on which they are then connected to the lines for the annotations 4.

Due to the high complexity and the large number of dependencies, a three-dimensional representation of the annotations 4, and if necessary of the artifacts 3 and process steps 2, is also desirable as a development, by which a user is able to navigate virtually. Here, the advantage lies in the greater clarity and intuitivism.

In accordance with an embodiment of the invention, the annotation metamodel 62 shown in FIG. 1 is used as a master to produce the annotations 4. For instance, the method may provide a way for a user order to define such an annotation metamodel 62. Here, the annotation metamodel 62 is used to define limits of multiplicities and/or cardinalities, as known to the person skilled in the art from databases. It is thus possible to determine, for instance, that a process step 2 always has to result precisely in one artifact 3, but may be dependent on any number of artifacts 3 as information sources. Another restriction would be, for instance, that annotations 4 can only exist between process steps 2 and artifacts 3 on the lowest hierarchy levels that can be shown in each case.

In an embodiment of the method, the annotations 4 are checked for conformity with the at least one annotation metamodel 62. To this end, suitable algorithms check the annotations 4 for formal conformity with the one (or several) defined annotation metamodels 62 at regular intervals (or initiated by a request from a user).

The method can be embodied as an independent computer program or also as a plug-in for existing CAD and project management applications. The program code required for these accesses databases in the CAD and project management applications over suitable software interfaces. References and/or URI's (Uniform Resource Identifier) are suitable here as a data link to these external databases.

The annotations 4 and the at least one annotation metamodel 62 are stored, for instance, in XML or a format derived therefrom. This is advantageous in that the annotation metamodel 62 and the annotations 4 can be read and used independently of organizations or manufacturers.

The process steps 2 and artifacts 3 can be shown using standardized symbols, as known, for instance, from description languages, such as UML or SysML and from process modeling standards according to ARIS.

It is also possible to subject the annotations 4 to further formal analyses as regards content using suitable algorithms. To this end, a check for consistency of the annotations 4 is included, for instance. Here, the following exemplary inconsistencies can be determined:
inextricable circular references,
process steps 2 which do not end in an artifact 3,
artifacts 3 which are not assigned to process step 2.

Furthermore, hotspots and/or bottlenecks can be identified, as known to the person skilled in the art within the context of databases, for instance, critical key components under the artifacts 3, process steps 2 and/or work packages of central importance, resource bottlenecks, cumulation of risks and critical paths in the production schedule.

All documents that are directly or indirectly relevant to a specific artifact 3 or a specific process step 2 can be compiled for document management Furthermore, the work status of all work packages that are directly or indirectly connected to a process step 2 or an artifact 3 can be compiled for configuration management.

The disclosed embodiments of the method in accordance with the invention can be used in different phases of plant engineering. In the case of preliminary order-independent activities, they are used to define and optimize the annotations 4. An integrated work and structural plan is hereby produced. This is generally valid for a previously defined spread of technical plants. In the subsequent order-dependent phase, the method in accordance with the disclosed embodiments assists with the project planning, by helping with the identification of documents that are required for a specific structural component (represented by one or several artifacts 3) of the technical system. Furthermore, the method in accordance with the disclosed embodiments assists with document and configuration management. It is possible to determine for instance whether all necessary artifacts 3 exist for a preferred process step 2 or which document status currently exists on account of the already processed process steps 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method of assisting planning of a technical system in which a microprocessor is programmed, the method comprising:
assigning, by the microprocessor, artifacts of the technical system to process steps, which are required to produce the artifacts, by producing annotations; and
enabling a user to detect and process the annotations aided by a graphical user interface.

12. The method as claimed in claim 11, wherein at least one artifact of the artifacts forms a mechatronic object.

13. The method as claimed in claim 11, wherein the annotations include input annotations that specify ones of the artifacts required for a process step, and wherein output annotations that specify others of the artifacts produced by the process steps.

14. The method as claimed in claim 11, wherein the annotations are shown three-dimensionally by the graphical user interface.

15. The method as claimed in claim 11, wherein at least one annotation metamodel forms a master for producing the annotations.

16. The method as claimed in claim 15, further comprising:
checking the annotations in a computer-assisted manner for conformity to the at least one annotation metamodel.

17. The method as claimed in claim 15, further comprising:
storing the annotations and the at least one annotation metamodel in extended mark-up language (XML) or a format derived therefrom.

18. The method as claimed in claim 11, further comprising:
checking the annotations in a computer-assisted manner for one of hotspots, bottlenecks or inconsistencies.

19. The method of claim 18, wherein said hotspots, bottlenecks or inconsistencies comprise one of inextricable circular references, the process steps which do not end in an artifact and the artifacts to which the process steps are unassigned.

20. A non-transitory machine-readable data carrier encoded with a computer program executing on a microprocessor which, when used on a computer, causes the microprocessor to assist planning of a technical system, the computer program comprising:
program code for assigning, by the microprocessor, artifacts of the technical system to process steps, which are required to produce the artifacts, by producing annotations; and
program code for enabling a user to detect and process the annotations aided by a graphical user interface.

21. A process in which a computer executes instructions set forth in a computer program executing on a microprocessor which, when used on the computer, causes the microprocessor to assist planning of a technical system, the computer program comprising:
program code for assigning, by the microprocessor, artifacts of the technical system to process steps, which are required to produce the artifacts, by producing annotations; and
program code for enabling a user to detect and process the annotations aided by a graphical user interface.
